(19) United States
(12) Patent Application Publication
(10) Pub. No.: US 2012/0136866 A1
(43) Pub. Date: May 31, 2012

(54) ASSISTING USERS TO INTERACT APPROPRIATELY TO CONFORM TO THE NORM OF THE SOCIAL NETWORKING GROUP

(75) Inventors: Bernadette A. Carter, Raleigh, NC (US); Al Chakra, Apex, NC (US); Oriana J. Love, Austin, TX (US)

(73) Assignee: International Business Machines Corporation, Armonk, NY (US)

(21) Appl. No.: 12/956,649

(22) Filed: Nov. 30, 2010

(51) Int. Cl. G06F 7/00

(52) U.S. Cl. 707/740; 707/E17.058

(57) ABSTRACT

A method, system and computer program product for assisting users to interact appropriately in social networking groups. Content posts in a social networking group are scanned and parsed in order to identify the events that led to these content posts. Each event is categorized and assigned a level of importance based on various factors, such as age, the number of comments and the environmental factors. These categorized events are grouped based on importance. A baseline of normal social acceptable behavior for the social networking group is established based on these grouped categorizations. Once a baseline of normal social acceptable behavior for the social networking group has been established, the user's content posts are analyzed in light of this baseline so that the user may be informed of potential faux pas in the social networking group and provided assistance to conform to the norm of that social networking group.

### TECHNICAL FIELD

The present invention relates to social networks, and more particularly to assisting users to interact appropriately to text messages, comments, events, etc. in a social networking group to conform to the norm of that social networking group.

### BACKGROUND

Many community Internet sites, such as for example, social networking sites, allow their users to represent themselves on the site as a basis for interacting socially with other members. Typically, this presentation of the user's self takes the form of a single “member page.” The user customizes this page for personality representation. For example, the user may populate the home page with personal information, photos, graphics, and/or any other content that the user believes is suitable for self-representation. Community sites generally provide means whereby some areas of a member page can be made accessible only to other users designed by the user as having a particular type of relationship (e.g., friends, family, contacts, etc.) thus protecting certain private information from public access.

In these communities, an initial set of founders send out messages inviting members of their own personal networks to join the site thereby forming a social networking group. New members repeat the process, growing the total number of members and links in the network. Sites then offer features such as automatic address book updates, viewable profiles, the ability to form new links through “introduction services,” and other forms of online social connections.

Depending on the particular social networking group a user belongs to or joins, there is an unspoken social protocol that becomes the norm in communicating within the social networking group. The norm varies widely depending on the particular social networking group.

Adhering to such norm and protocol is one way to ensure that the user is on the other members' favorable list as well as to successfully augment or advertise his/her business within the social networking group. However, by making faux pas in the group, the user may no longer be contacted by other members in the social networking group and may also reduce the ability to successful market his/her business to these members. In many instances, the user commits these faux pas without realizing it.

For example, suppose an individual, John in our example, joins a social networking group on Facebook® to communicate with a group of distant relatives on Facebook®. John responds to multiple posts and others in the group respond to his posts. Everything seems to be going well until one day he feels that he has fallen out of favor with some of the other members in the group. John tried to figure out what caused him to be out of favor with the other members in the group but to no avail. He later gives up and leaves the group feeling embarrassed and puzzled. While in reality, the reason why other members have fallen out of favor with John is because John did not communicate a sympathy comment in connection with the death of one of his distant relatives. Because it is customary in this social networking group to communicate a sympathy comment when someone in the family passes away, the rest of the group started to believe that John made a disrespectful gesture by not expressing his sympathy thereby changing the relationship with him.

In another example, suppose that John joins his college alumni's social networking group to connect with old classmates. From day one, John starts blasting this group with wonderful comments about what he is doing on a daily basis and his opinions about news events, just like during his college days. After a few days, John notices that his college friends start ignoring and avoiding him on the social network platform. John does not know why he has fallen out of favor. In reality, the established norm or culture of this group is to post a comment only when a life changing event occurs. Since they have been out of touch for so many years, they usually do not share their granular life events, only the very important ones.

As a result, it is important for the user to be aware of potential faux pas in a social networking group and to conform to the norm of that social networking group.

### BRIEF SUMMARY

In one embodiment of the present invention, a method for assisting users to interact appropriately in social networking groups comprises scanning content posts in a social networking group. The method further comprises parsing the scanned content posts. Additionally, the method comprises identifying one or more events that led to the content posts. Furthermore, the method comprises categorizing the one or more events. In addition, the method comprises assigning a level of importance to each of the one or more categorized events. The method further comprises grouping the categorized events based on importance. Additionally, the method comprises establishing, by a processor of a social network analyzer, a baseline of normal social acceptable behavior for the social networking group based on the grouped categorizations.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a social network system configured in accordance with an embodiment of the present invention;

FIG. 2 illustrates a hardware configuration of a social network analyzer configured in accordance with an embodiment of the present invention;

FIG. 3 illustrates the software components of the program for assisting users participating in a social networking group to conform to the norm of that social networking group in accordance with an embodiment of the present invention;

FIG. 4 is a flowchart of a method for establishing a baseline of normal social acceptable behavior for a social networking group in accordance with an embodiment of the present invention;

FIG. 5 is a flowchart of a method for advising a user to interact in connection with a content post to conform to the norm of that social networking group in accordance with an embodiment of the present invention; and

FIG. 6 is a flowchart of a method for instructing the user of a social networking group regarding using appropriate content and using an appropriate amount of interactions in the social networking group in accordance with an embodiment of the present invention.

### DETAILED DESCRIPTION

The present invention comprises a method, system and computer program product for assisting users to interact appropriately in social networking groups. In one embodiment of the present invention, content posts in a social networking group are scanned and parsed in order to identify the events that led to these content posts. Each event is categorized, such as based on topic (e.g., holiday, birthday), and assigned a level of importance based on various factors, such as age (refers to the amount of time that has transpired since the author issued the initial content post regarding the event), the number of comments and the environmental factors (e.g., proximity, both physically and virtually, of the author of the content post relating to the event and the user in question). These categorized events are grouped based on importance. A baseline of normal social acceptable behavior for the social networking group is established based on these grouped categorizations. Once a baseline of normal social acceptable behavior for the social networking group has been established, then a determination may be made as to whether a user needs to respond to a content post or whether the content of the user's posts are inappropriate or whether the user is posting an inappropriate amount of interactions (e.g., comments) for the significance of the event being discussed. In this manner, the user may be informed of potential faux pas in the social networking group and provided assistance to conform to the norm of that social networking group.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

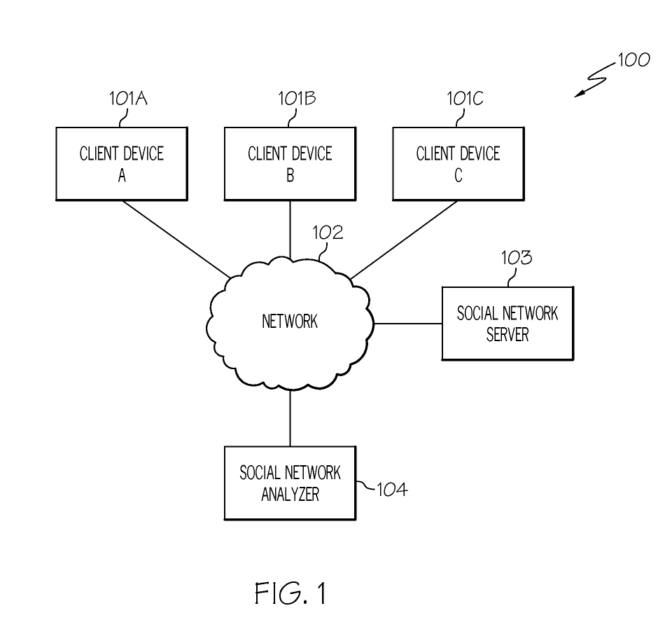

Referring now to the Figures in detail, FIG. 1 illustrates a social network system 100 configured in accordance with an embodiment of the present invention. Referring to FIG. 1, social network system 100 includes a community of users using client devices 101A-101C (identified as “Client Device A,” “Client Device B,” and “Client Device C,” respectively, in FIG. 1) to be involved in social network system 100. Client devices 101A-101C may collectively or individually be referred to as client devices 101 or client device 101, respectively. Client device 101 may be a personal computing system, a mobile phone, a personal digital assistance (PDA), a gaming unit, a portable computing unit, and the like.

Client devices 101 may participate in the social network by communicating (by wire or wirelessly) over a network 102, which may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

System 100 further includes a social network server 103, which may be a web server configured to offer a social networking and/or microblogging service, enabling users of client devices 101 to send and read other users' content posts. “Content posts,” as used herein, refer to posts that include any one or more of the following: text (e.g., comments, sub-comments and replies), audio, video images, etc. Furthermore, social network server 103 may be configured to store user profiles and accounts of users involved in social networking groups. Social network server 103 is connected to network 102 by wire or wirelessly. While FIG. 1 illustrates a single social network server 103, it is noted for clarity that multiple servers may be used to implement the social networking and/or microblogging service. Furthermore, each server may have different functions (e.g., a sever configured to store user profiles, a web server to run the social network site). Additionally, user profiles and accounts may be stored in one or more databases (not shown) connected to social network server 103.

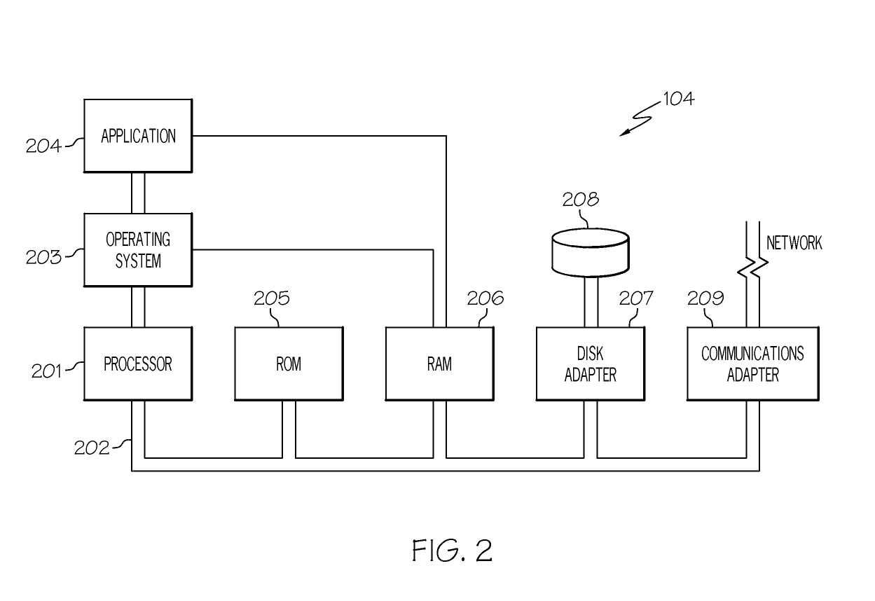

System 100 further includes a social network analyzer 104 connected to network 102 by wire or wirelessly. Social network analyzer 104 is configured to assist users of client devices 101 to interact appropriately in social networking groups as discussed in further detail below. A description of the hardware configuration of social network analyzer 104 is provided below in connection with FIG. 2.

System 100 is not to be limited in scope to any one particular network architecture. System 100 may include any number of clients 101, social network servers 103 and social network analyzers 104. Furthermore, in one embodiment, social network analyzer 104 may be part of social network server 103.

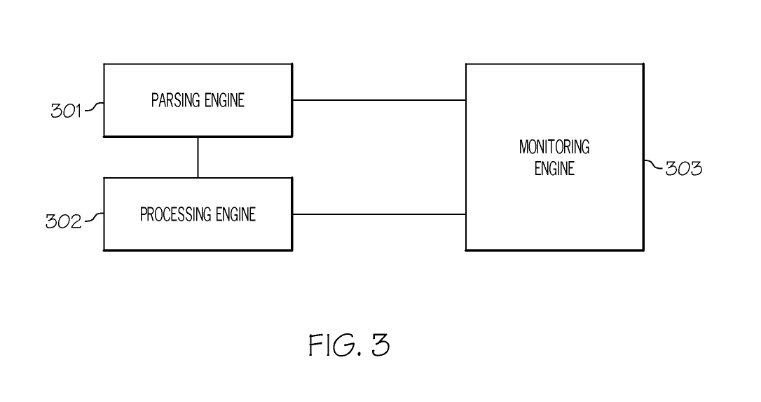

Referring now to FIG. 2, FIG. 2 illustrates a hardware configuration of a social network analyzer 104 (FIG. 1) which is representative of a hardware environment for practicing the present invention. Referring to FIG. 2, social network analyzer 104 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a program for assisting users to interact appropriately in social networking groups, as discussed further below in association with FIGS. 3-6.

Referring again to FIG. 2, read-only memory (“ROM”) 205 is coupled to system bus 202 and includes a basic input/output system (“BIOS”) that controls certain basic functions of social network analyzer 104. Random access memory (“RAM”) 206 and disk adapter 207 are also coupled to system bus 202. It should be noted that software components including operating system 203 and application 204 may be loaded into RAM 206, which may be social network analyzer's 104 main memory for execution. Disk adapter 207 may be an integrated drive electronics (“IDE”) adapter that communicates with a disk unit 208, e.g., disk drive. It is noted that the program for assisting users to interact appropriately in social networking groups, as discussed further below in association with FIGS. 3-6, may reside in disk unit 208 or in application 204.

Social network analyzer 104 may further include a communications adapter 209 coupled to bus 202. Communications adapter 209 interconnects bus 202 with an outside network (network 102) thereby allowing social network analyzer 104 to communicate with client devices 101 as well as to scan and parse content posts made by users of client devices 101.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to product a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, adhering to the norm and protocol of a social network group is one way to ensure that the user is on the other members' favorable list as well as to successfully augment or advertise his/her business or positive traits within the social network group. However, by making faux pas in the group, the user may no longer be contacted by other members in the social network group and may also reduce the ability to successful market his/her business to these members. In many instances, the user commits these faux pas without realizing it. As a result, it is important for the user to be aware of potential faux pas in a social networking group and to conform to the norm of that social networking group.

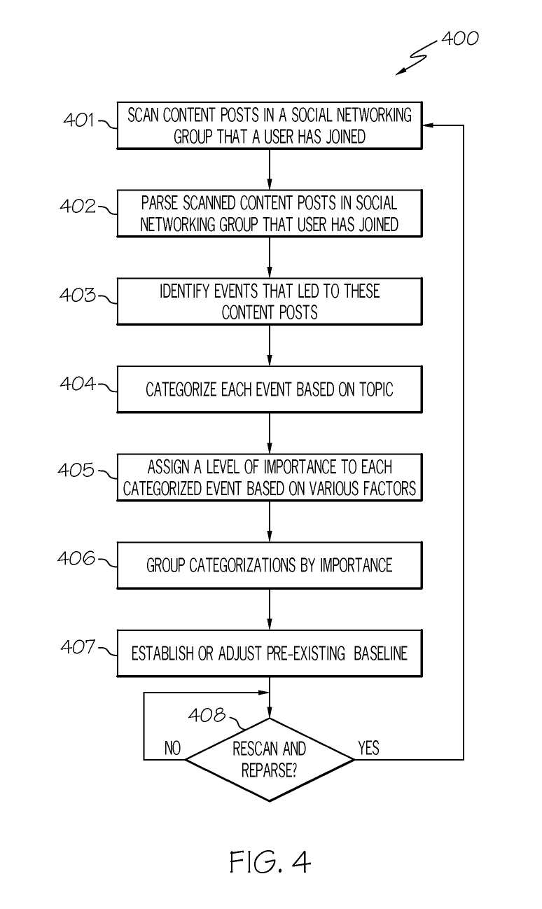

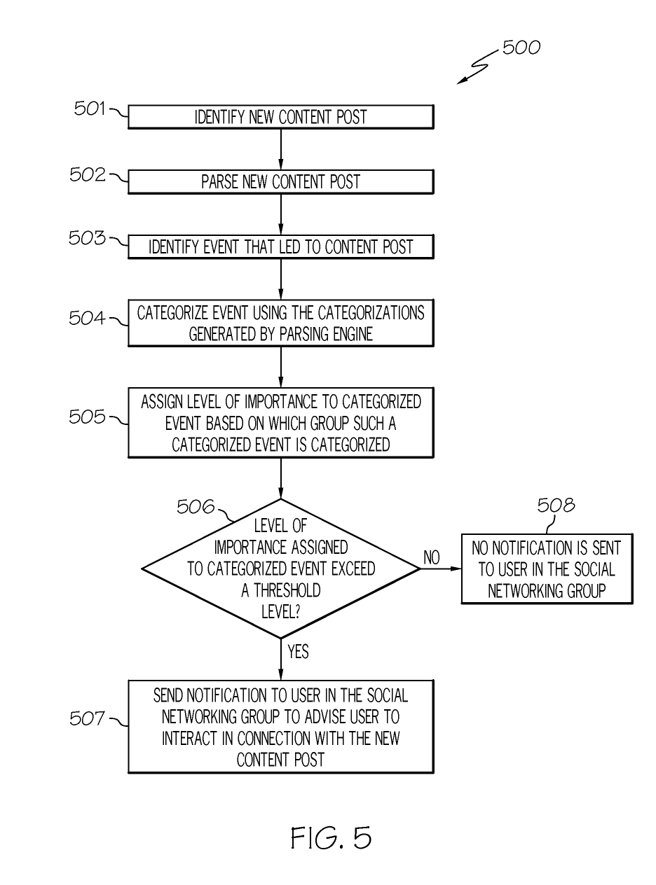

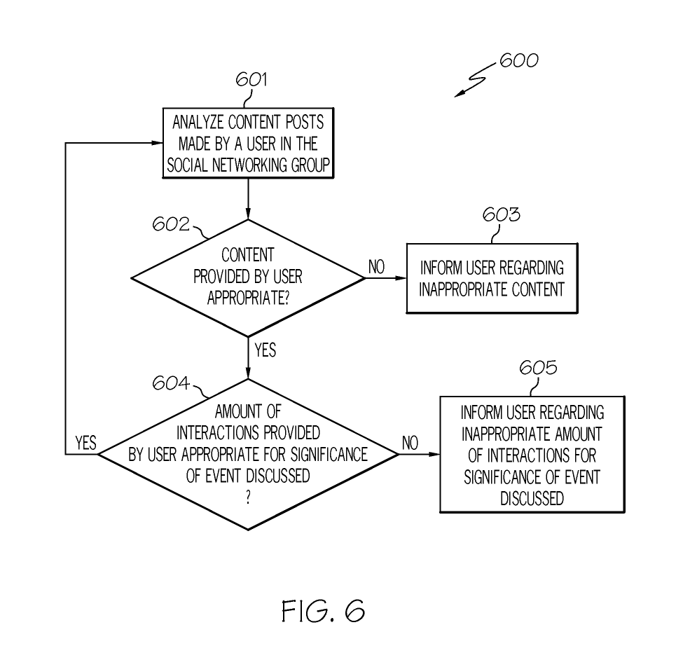

The principles of the present invention provide a means for assisting users of client devices 101 (FIG. 1) participating in a social network group to conform to the norm of that social network group as discussed below in connection with FIGS. 3-6. FIG. 3 illustrates the software components of the program used for assisting users of client devices 101 participating in a social network group to conform to the norm of that social network group. FIG. 4 is a flowchart of a method for establishing a baseline of normal social acceptable behavior for a social network group. FIG. 5 is a flowchart of a method for advising a user to interact in connection with a content post to conform to the norm of that social networking group. FIG. 6 is a flowchart of a method for instructing the user of a social networking group regarding using appropriate content and using an appropriate amount of interactions in the social networking group.

Referring to FIG. 3, in conjunction with FIGS. 1-2, as stated above, FIG. 3 illustrates the software components of a program for assisting users of client devices 101 participating in a social network group to conform to the norm of that social network group in accordance with an embodiment of the present invention. In one embodiment, these software components may reside in application 204. The following presents a brief description of these software components, where the functionalities of these components will be discussed in greater detail in connection with FIGS. 4-6.

The software components include a parsing engine 301 configured to scan and parse the content posts made by users in a social networking group. Furthermore, parsing engine 301 is configured to identify events that led to these content posts and to categorize such events, such as based on topics (e.g., birthdays, anniversaries). Each event may be assigned a level of importance (e.g., from important to insignificant) based on various factors, such as age and the number of comments related to the event. Age refers to the amount of time that has transpired since the author issued the initial content post regarding the event. For example, an event that is two hours old and has twenty comments will be ranked higher than an event that is thirty days old and has twenty-five comments. Additionally, events may be assigned a level of importance based on environmental factors, such as relationship and proximity (both physically and virtually) of the author of the content post relating to the event and to the user in question. Virtual proximity refers to the amount of interaction the user has recently had with the author of the content post relating to the event. Other examples of factors used to assign a level of importance include the sharing of activities/references, such as the sharing of an application, photo, image or article. The categorizations generated by parsing engine 301 are grouped together by importance.

In one embodiment, parsing engine 301 rescans and reparses the content posts in the social networking group at a user defined frequency.

The software components further include a processing engine 302 which uses the grouped categorizations (categories grouped by importance) generated by parsing engine 301 to establish a baseline of normal social acceptable behavior for that social networking group. The baseline can be readjusted by processing engine 302 when parsing engine 301 rescans and reparses the content posts in the social networking group.

Additionally, the software components include a monitoring engine 303 configured to advise a user when to interact (e.g., add a comment) in connection with a content post using the grouped categorizations generated by parsing engine 301 and using the established baseline of normal social acceptable behavior for that social networking group. Furthermore, monitoring engine 303 is configured to instruct the user of a social network group regarding appropriate content and the appropriate amount of interactions (e.g., comments, actions) to be used using the established baseline of normal social acceptable behavior for that social networking group. Hence, once a baseline of normal social acceptable behavior for the social networking group has been established by processing engine 302, the user's content posts are analyzed by monitoring engine 303 in light of this baseline so that the user may be informed of potential faux pas in the social networking group and provided assistance to conform to the norm of that social networking group.

As stated above, a more detail discussion of these components is provided below in connection with FIGS. 4-6.

FIG. 4 is a flowchart of a method 400 for establishing a baseline of normal social acceptable behavior for a social network group in accordance with an embodiment of present invention.

Referring to FIG. 4, in conjunction with FIGS. 1-3, in step 401, parsing engine 301 scans the content posts in a social networking group that a user has joined. Content posts may include original comments, sub-comments, replies, images, video, audio, etc.

In step 402, parsing engine 301 parses the scanned content posts in the social networking group that the user has joined.

In step 403, parsing engine 301 identifies the events (e.g., regional track meet, birthday, holiday, birth of a child) that led to these content posts.

In step 404, parsing engine 301 categorizes each event, such as based on topic (e.g., distant relative).

In step 405, parsing engine 301 assigns a level of importance to each of the categorized events based on various factors, such as age, number of comments and environmental factors. Age refers to the amount of time that has transpired since the author issued the initial content post regarding the event. Environmental factors refer to the proximity (both physically and virtually) of the author of the content post relating to the event and to the user in question. Virtual proximity refers to the amount of interaction the user has recently had with the author of the content post relating to the event.

In step 406, parsing engine 301 groups these categorizations (categorized events generated in step 404) based on importance.

In step 407, processing engine 302 establishes a baseline of normal social acceptable behavior for the social networking group based on these grouped categorizations.

In step 408, a determination is made by parsing engine 301 whether to rescan and reparse the content posts in the social networking group. In one embodiment, parsing engine 301 rescans and reparses the content posts in the social networking group at a user defined frequency.

If parsing engine 301 is to rescan and reparse the content posts in the social networking group, then parsing engine 301 rescans the content posts in the social networking group in step 401. Upon parsing engine 301 rescanning and performing steps 402-406, processing engine 302 adjusts the baseline of normal social acceptable behavior for the social networking group based on the newly grouped categorizations.

If, however, parsing engine 301 determines that it is not the appropriate time to rescan and reparse the content posts in the social networking group, then, parsing engine 301 later checks again to determine if it is the appropriate time to rescan and reparse the content posts in the social networking group in step 408.

In some implementations, method 400 may include other and/or additional steps that, for clarity, are not depicted. Further, in some implementations, method 400 may be executed in a different order presented and that the order presented in the discussion of FIG. 4 is illustrative. Additionally, in some implementations, certain steps in method 400 may be executed in a substantially simultaneous manner or may be omitted.

A method for advising a user to interact (e.g., add a comment) in connection with a content post is discussed below in association with FIG. 5.

FIG. 5 is a flowchart of a method 500 for advising a user of a social networking group to interact in connection with a content post to conform to the norm of that social networking group in accordance with an embodiment of the present invention.

Referring to FIG. 5, in conjunction with FIGS. 1-4, in step 501, monitoring engine 303 identifies a new content post made after processing engine 302 establishes a baseline of normal social acceptable behavior for the social networking group.

In step 502, monitoring engine 303 parses the content post. In step 503, monitoring engine 303 identifies the event that led to the content post. In step 504, monitoring engine 303 categorizes the event using the categorizations generated by parsing engine 301 in step 404 of FIG. 4.

In step 505, monitoring engine 303 assigns a level of importance to the categorized event based on which group such a categorized event is categorized. As discussed above, parsing engine 301 groups categorizations (categorized events generated in step 404) based on importance in step 406 of FIG. 4. Once monitoring engine 303 determines which of these grouped categorizations includes the categorized event, then the level of importance of that group is assigned to the categorized event.

In step 506, a determination is made by monitoring engine 303 as to whether the level of importance assigned to the categorized event exceeds a threshold level which is determined based on the baseline of normal social acceptable behavior for the social networking group.

If the level of importance assigned to the categorized event exceeds a threshold level, then, in step 507, monitoring engine 303 sends a notification to the user in the social networking group to advise the user to interact (e.g., comment, share, show approval or any other type of interaction that the platform may provide for interaction) in connection with the new content post. For example, suppose an author posted a content post regarding taking second place at a regional track meet. If this event is deemed important enough to warrant a response in this social networking group, where such a response is deemed to be normal socially acceptable behavior, then monitoring engine 303 informs the user who received this post to respond to it.

If, however, the level of importance assigned to the categorized event does not exceed the threshold level, then, in step 508, monitoring engine 303 does not send a notification to the user in the social networking group who received the post.

In some implementations, method 500 may include other and/or additional steps that, for clarity, are not depicted. Further, in some implementations, method 500 may be executed in a different order presented and that the order presented in the discussion of FIG. 5 is illustrative. Additionally, in some implementations, certain steps in method 500 may be executed in a substantially simultaneous manner or may be omitted.

A method for instructing the user of a social networking group regarding using appropriate content and using an appropriate amount of interactions is discussed below in association with FIG. 6.

FIG. 6 is a flowchart of a method 600 for instructing the user of a social networking group regarding using appropriate content and using an appropriate amount of interactions in the social networking group in accordance with an embodiment of the present invention.

Referring to FIG. 6, in conjunction with FIGS. 1-3 and 5, in step 601, monitoring engine 303 analyzes the content posts made by a user in the social networking group. Analyzing includes evaluating the content of these content posts as well as identifying the number of comments made in connection with each of the categorized events (see step 504 which can be applied to content posts made by user in question) that were assigned a level of importance (see step 505 which can be applied to content posts made by user in question).

In step 602, a determination is made by monitoring engine 303 as to whether the content provided by the user in these posts are appropriate based on the baseline of normal social acceptable behavior for this social networking group. For example, if the user is using foul language in a social networking group for Christians, then it may be deemed to be unacceptable social behavior for such a social networking group.

If the content provided by the user in these posts are inappropriate based on the baseline of normal social acceptable behavior for this social networking group, then, in step 603, monitoring engine 303 informs the user that the content provided by the user is inappropriate based on the baseline of normal social acceptable behavior for this social networking group.

If, however, the content provided by the user in these posts are appropriate, then, in step 604, a determination is made by monitoring engine 303 as to whether the amount of interactions (e.g., comments) provided by the user in these posts are appropriate for the significance of the event being discussed based on the baseline of normal social acceptable behavior for this social networking group. For example, if the user makes twenty comments in connection with having a doughnut in a social networking group for alumni, then such an amount of comments for such an event may be deemed to be unacceptable social behavior for such a social networking group.

If the amount of interactions provided by the user in these posts are inappropriate for the significance of the event being discussed based on the baseline of normal social acceptable behavior for this social networking group, then, in step 605, monitoring engine 303 informs the user that the amount of interactions in these posts are inappropriate for the significance of the event being discussed based on the baseline of normal social acceptable behavior for this social networking group.

If, however, the amount of interactions provided by the user in these posts are appropriate for the significance of the event, then monitoring engine 303 analyzes the next batch of new content posts made by the user in the social networking group in step 601.

In some implementations, method 600 may include other and/or additional steps that, for clarity, are not depicted. Further, in some implementations, method 600 may be executed in a different order presented and that the order presented in the discussion of FIG. 6 is illustrative. Additionally, in some implementations, certain steps in method 600 may be executed in a substantially simultaneous manner or may be omitted.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

1. A method for assisting users to interact appropriately in social networking groups, the method comprising:
scanning content posts in a social networking group;
parsing said scanned content posts;
identifying one or more events that led to said content posts;
categorizing said one or more events;
assigning a level of importance to each of said one or more categorized events;
grouping said categorized events based on importance; and
establishing, by a processor of a social network analyzer, a baseline of normal social acceptable behavior for said social networking group based on said grouped categorizations.

2. The method as recited in claim 1, wherein said content posts comprise one or more of the following: comments, sub-comments, replies, images, video and audio.

3. The method as recited in claim 1 further comprising:
assigning said level of importance to each of said one or more categorized events based on one or more of the following: age, number of comments and environmental factors.

4. The method as recited in claim 1 further comprising:
rescanning and reparsing content posts in said social networking group; and
adjusting said baseline of normal social acceptable behavior for said social networking group based on said rescanning and reparsing content posts in said social networking group.

5. The method as recited in claim 1 further comprising:
identifying a content post after establishing said baseline of normal social acceptable behavior for said social networking group;
parsing said content post;
identifying an event that led to said content post;
categorizing said event based on said grouped categorizations;
assigning a level of importance based on which group of said grouped categorizations said categorized event is categorized; and
sending a notification to a user to advise said user to interact in connection with said content post in response to said level of importance exceeding a threshold level determined by said baseline of normal social acceptable behavior for said social networking group.

6. The method as recited in claim 1 further comprising:
analyzing content of content posts provided by a user in said social networking group; and
informing said user that said content provided by said user is inappropriate based on said baseline of normal social acceptable behavior for said social networking group.

7. The method as recited in claim 1 further comprising:
analyzing content posts in connection with an event provided by a user in said social networking group; and
informing said user that an amount of interactions in said content posts are inappropriate for significance of said event based on said baseline of normal social acceptable behavior for said social networking group.

8. A computer program product embodied in a computer readable storage medium for assisting users to interact appropriately in social networking groups, the computer program product comprising the programming instructions for:
scanning content posts in a social networking group;
parsing said scanned content posts;
identifying one or more events that led to said content posts;
categorizing said one or more events;
assigning a level of importance to each of said one or more categorized events;
grouping said categorized events based on importance; and
establishing a baseline of normal social acceptable behavior for said social networking group based on said grouped categorizations.

9. The computer program product as recited in claim 8, wherein said content posts comprise one or more of the following: comments, sub-comments, replies, images, video and audio.

10. The computer program product as recited in claim 8 further comprising the programming instructions for:
assigning said level of importance to each of said one or more categorized events based on one or more of the following: age, number of comments and environmental factors.

11. The computer program product as recited in claim 8 further comprising the programming instructions for:
rescanning and reparsing content posts in said social networking group; and
adjusting said baseline of normal social acceptable behavior for said social networking group based on said rescanning and reparsing content posts in said social networking group.

12. The computer program product as recited in claim 8 further comprising the programming instructions for:
identifying a content post after establishing said baseline of normal social acceptable behavior for said social networking group;
parsing said content post;
identifying an event that led to said content post;
categorizing said event based on said grouped categorizations;
assigning a level of importance based on which group of said grouped categorizations said categorized event is categorized; and
sending a notification to a user to advise said user to interact in connection with said content post in response to said level of importance exceeding a threshold level determined by said baseline of normal social acceptable behavior for said social networking group.

13. The computer program product as recited in claim 8 further comprising the programming instructions for:
analyzing content of content posts provided by a user in said social networking group; and
informing said user that said content provided by said user is inappropriate based on said baseline of normal social acceptable behavior for said social networking group.

14. The computer program product as recited in claim 8 further comprising the programming instructions for:
analyzing content posts in connection with an event provided by a user in said social networking group; and
informing said user that an amount of interactions in said content posts are inappropriate for significance of said event based on said baseline of normal social acceptable behavior for said social networking group.

15. A system, comprising:
a memory unit for storing a computer program for assisting users to interact appropriately in social networking groups; and
a processor coupled to said memory unit, wherein said processor, responsive to said computer program, comprises:
circuitry for scanning content posts in a social networking group;
circuitry for parsing said scanned content posts;
circuitry for identifying one or more events that led to said content posts;
circuitry for categorizing said one or more events;
circuitry for assigning a level of importance to each of said one or more categorized events;
circuitry for grouping said categorized events based on importance; and
circuitry for establishing a baseline of normal social acceptable behavior for said social networking group based on said grouped categorizations.

16. The system as recited in claim 15, wherein said processor further comprises:
circuitry for assigning said level of importance to each of said one or more categorized events based on one or more of the following: age, number of comments and environmental factors.

17. The system as recited in claim 15, wherein said processor further comprises:
circuitry for rescanning and reparsing content posts in said social networking group; and
circuitry for adjusting said baseline of normal social acceptable behavior for said social networking group based on said rescanning and reparsing content posts in said social networking group.

18. The system as recited in claim 15, wherein said processor further comprises:
circuitry for identifying a content post after establishing said baseline of normal social acceptable behavior for said social networking group;
circuitry for parsing said content post;
circuitry for identifying an event that led to said content post;
circuitry for categorizing said event based on said grouped categorizations;
circuitry for assigning a level of importance based on which group of said grouped categorizations said categorized event is categorized; and
circuitry for sending a notification to a user to advise said user to interact in connection with said content post in response to said level of importance exceeding a threshold level determined by said baseline of normal social acceptable behavior for said social networking group.

19. The system as recited in claim 15, wherein said processor further comprises:
circuitry for analyzing content of content posts provided by a user in said social networking group; and
circuitry for informing said user that said content provided by said user is inappropriate based on said baseline of normal social acceptable behavior for said social networking group.

20. The system as recited in claim 15, wherein said processor further comprises:
circuitry for analyzing content posts in connection with an event provided by a user in said social networking group; and
circuitry for informing said user that an amount of interactions in said content posts are inappropriate for significance of said event based on said baseline of normal social acceptable behavior for said social networking group.
